(19) United States
(12) Patent Application Publication
(10) Pub. No.: US 2011/0179068 A1
(43) Pub. Date: Jul. 21, 2011

(54) COMPUTER IMPLEMENTED PROCESS FOR CREATING AN OVERALL HEALTH WELLNESS DATABASE FOR A PLURALITY OF PATIENTS

(76) Inventor: John Patrick O'Brien, Fallbrook, CA (US)

(21) Appl. No.: 13/010,679

(22) Filed: Jan. 20, 2011

Related U.S. Application Data
(60) Provisional application No. 61/352,923, filed on Jun. 9, 2010.
(60) Provisional application No. 61/297,196, filed on Jan. 21, 2010.

(51) Int. Cl. G06F 17/30

(52) U.S. Cl. 707/769; 707/E17.014

(57) ABSTRACT

A total fitness system uses a virtual trainer and/or a database of health information. Based upon certain information provided by a user, the virtual trainer can generate a workout routine and provide detailed guidance and instruction on how to carry out the routine. The database of health information can provide a user with supplement, diet, nutrition and other information, as well as, alternative exercises to perform based upon targeted muscles. A healthcare provider can access the system as part of patient treatment, or an insurance carrier can access the system for purposes of evaluating medical risk in underwriting medical or life policies. Furthermore, an individual's overall wellness can be evaluated by compiling and storing in the database a multitude of parameters which covers all aspects of one's life. This information can then be retrieved and evaluated by various organizations or users.

### BACKGROUND OF THE INVENTION

This invention relates generally to a system for providing physical fitness training. More specifically, the present invention relates to a system for providing physical fitness training using a computerized virtual trainer that selects various exercises, prepares a training program, describes and demonstrates how exercises are performed and monitors a user's performance.

Getting and staying in shape is a common theme in today's society. Particularly, properly conditioning (exercising) the body or particular body parts is important as people grow older and the body or particular body parts may become more susceptible (vulnerable) to disease or injury. Additionally, many people may get and/or stay in shape by playing a new sport (e.g., tennis), and properly conditioning (training) the body for the particular new sport is important to help avoid injury as body parts (e.g., muscles) perform new functions. Also, optimally (successfully) conditioning the body during these programs may include an associated nutrition plan to help achieve and maintain the optimal weight for the exerciser.

Currently, however, to achieve these goals a user has limited options, none of which offer a great amount of convenience and flexibility to the user. One option is to buy an exercise book that commonly only offers generalized information regarding an exercise program but which cannot offer a customized exercise program. A second option is to go to a healthcare or fitness facility/professional and receive customized, personal guidance that may include high costs and still limits flexibility and convenience to the user. People join health clubs today because of how plush or state of the art the club is, which leads to grander visions of achieved health and/or fitness. A third option is to try current exercise equipment and software products that offer exercise programs for the user, but are not sport specific nor body or body part specific and also omit a nutrition plan. A fourth option is to try the internet for an interactive customized exercise program, but these programs are essentially the second option over the internet and therefore still limit optimum user convenience and flexibility and do not incorporate nutrition.

Accordingly, there is a need for an efficient process which offers customized exercise programs to a particular user body or body part or to condition the user for a particular sport, and that may optionally include a nutrition plan while still providing a great amount of flexibility and convenience to the user. The present invention fulfills these needs and provides other related advantages.

### SUMMARY OF THE INVENTION

The present invention is directed to an exercise system whereby a user has access to a virtual trainer and database of health information. The virtual trainer assists a user in creating a workout routine tailored to the user's characteristics (age, height and weight), fitness goals (weight loss, muscle building, muscle toning, physical therapy, etc.), and limitations (injuries, disabilities, etc.). A user can review a proposed fitness plan and modify the plan based upon personal preferences. Access to the database of health information includes an encyclopedia or atlas of exercises organized by targeted muscle groups. A user can add or replace an exercise in a routine for a specific muscle group based upon this information.

The virtual trainer also provides a user with detailed instructions on how to perform each exercise in written, audio and video formats. Such instructions demonstrate the proper way to perform each exercise to achieve optimum results while reducing the risk of injury. The workout routine will also tell a user how much weight to use, how many repetitions/sets to perform, how long each repetition should be, and how long to rest between sets.

The system can be tailored to a particular fitness club so that only exercises using the equipment present in the fitness club are included in the routine. The system may also include display screens attached to or associated with each piece of exercise equipment in the fitness club so that a user receive instruction at a particular piece of equipment rather than at returning to a central location after each exercise. An additional benefit is that the user can receive additional instruction between each set. A user may also employ a monitor to detect physical statistics during a workout. Such a monitor can results in a user receiving instantaneous feedback about a workout at a particular machine.

The database of health information includes an encyclopedia or atlas of exercises that can be performed. The exercises are organized by target muscle group to make searching easier. The encyclopedia is tailored to list those exercises that can be performed with equipment in the fitness club. The atlas is a comprehensive listing of exercises regardless of what is present in the current fitness club. The database of health information also includes a library of supplements, vitamins and diets to assist a user in preparing a complete fitness plan. A user may also access research papers and other articles relating to a particular fitness goal, exercise, muscle group, etc.

The system may be linked to multiple fitness clubs so that a user may access and employ the same fitness routine at any of multiple fitness clubs. A user may also remotely access the system via the Internet or other remote means to continue a workout or refer to a fitness plan when away from the fitness club. A medical provider can also access the system to view the fitness plan of a particular patient that is a user of the system. This allows the medical provider to review/approve a user's fitness plan, monitor the user's progress, and modify any fitness plan as necessary to accommodate the patient's progress. The medical provider can also upload medical reports and other information to the user's fitness plan to have a more comprehensive report of the patient in a single location.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a flow chart illustrating an activity screen for the virtual training system of the present invention;

FIG. 2 is a flow chart illustrating a workout plan screen for the virtual training system of the present invention;

FIG. 3 is a flow chart illustrating a client workout instruction screen for the virtual training system of the present invention;

FIG. 4 is a flow chart illustrating a “last workout” instruction screen for the virtual training system of the present invention;

FIG. 5 is a flow chart illustrating a medical professional activity screen for the virtual training system of the present invention;

FIG. 6 is a flow chart illustrating an upload medical records screen for the virtual training system of the present invention;

FIG. 7 is a flow chart illustrating an options screen for remote use of the virtual training system of the present invention;

FIG. 8 is a flow chart illustrating an exercise library screen for the virtual training system of the present invention;

FIG. 9 is a flow chart illustrating a muscle group selection screen for the virtual training system of the present invention;

FIG. 10 is a flow chart illustrating an exercise atlas screen for the virtual training system of the present invention;

FIG. 11 is a flow chart illustrating a science of exercise screen for the virtual training system of the present invention;

FIG. 12 is a flow chart illustrating a reports and studies screen for the virtual training system of the present invention;

FIG. 13 is a flow chart illustrating a health database screen for the virtual training system of the present invention;

FIG. 14 is a flow chart illustrating a total fitness screen for the virtual training system of the present invention;

FIG. 15 is a flow chart illustrating a custom applications screen for the virtual training system of the present invention;

FIG. 16 is a flow chart illustrating a trusted partners screen for the virtual training system of the present invention;

FIG. 17 is a flow chart illustrating a history screen for the virtual training system of the present invention;

FIG. 18 is a flow chart illustrating a history screen for the virtual training system of the present invention;

FIG. 19 is a flow chart illustrating a record options screen for the virtual training system of the present invention;

FIG. 20 is a flow chart illustrating a real time feedback screen for the virtual training system of the present invention; and

FIG. 21 is a diagram illustrating the various wellness parameters that can be compiled into the system's database.

### DETAILED DESCRIPTION OF THE PREFERRED EMBODIMENTS

The present invention is generally directed to a system for providing physical fitness training. More specifically, the present invention is directed to a system for providing physical fitness training using a computer. The computer uses a virtual trainer that selects various exercises, prepares a training program, describes and demonstrates how exercises are performed and monitors a user's performance.

The system is designed to be used by many different entities, including companies, organizations, or equipment manufacturers that are involved in people's health and educating them about the same. The system may include added functionality as a repository for electronic health records, i.e., medical and exercise records. A centralized record system as described herein would benefit medical professionals, insurance companies, government run health plans, as well as, the individuals using the system. In this way, the system marries a patient's medical records with a record of the user's wellness/fitness history for a more complete picture of a user's state of health.

Medical professionals can use the system to monitor a patient's wellness plan through empirical data rather than relying on a patent's anecdotal evidence. Similarly, insurance companies can more accurately evaluate risk in underwriting by taking into account lifestyle choices.

A user will view this system as state of the art and further motivation to exercise and stay in shape. A fitness club will view this system as a work saver. With the virtual training systems, staff will not need to walk around advising (or ill-advising) people on how to perform exercises. Staff can spend their time generating revenue for the club by talking to or signing up new/prospective members.

In providing guidance on how to perform a particular exercise, the system instructs and demonstrates—through audio and video display—exactly how to perform each exercise correctly. This instruction and demonstration includes word-for-word explanation of the movement, pace and duration each time a particular exercise is performed. Such instruction and demonstration can have the effect of limiting the liability of a particular entity for any injuries suffered by a user of exercise equipment.

The system uses a virtual trainer to instruct and demonstrate each exercise. The verbal and visual demonstration of each exercise by the virtual trainer shows the user the correct way to perform the exercise at each workout. Such repetition is correct and accurate every time. There is no variation as there may be with a personal trainer.

To employ the virtual trainer, each piece of equipment comes with or can be retrofitted with a monitor screen. From the monitor screen on any piece of equipment, a user can receive an itinerary of the exercises to be performed during a particular workout. Through the monitor screen, the virtual trainer shows the user which exercises can be performed at a particular machine and how to perform each exercise through video demonstration or other comparable means. The virtual trainer also indicates which body parts are used by a particular exercise.

The virtual trainer can be programmed with proprietary knowledge of each exercise and piece of equipment contained in a fitness club. The knowledge can include specific details not known or communicated by all but a handful of fitness trainers in the industry. For example, the virtual trainer can be programmed with knowledge of specific movements and exercises to train and develop the lower inner bicep, the midrange inner bicep, the peak of the inner bicep and the same areas for the outer bicep.

The virtual trainer can also store and recall a personal workout program for a user on any piece of exercise equipment that has a monitor screen. When a user inputs their personal pin#, ID card or other code, the virtual trainer will access the user's files on the database and have access to the specific exercise(s) being performed, and historical data on previous workouts, including weight used, number of repetitions, number of sets, duration of workout. Such information is available in any fitness club or facility that is uses the virtual training system and is linked up with the system in other clubs. The workout records are remotely accessible by a user over the internet or similar means from home or on the road so that the workout can be continued when away from the fitness club. A doctor or physician can also remotely access the workout records, as well as, any medical records that may have been uploaded to the system, to monitor the progress of a patient.

The system includes a main library that includes a comprehensive resource of fitness exercises that can be performed. Depending upon where the library is accessed from, the information presented can be tailored to prioritize or emphasize exercises that can be performed using equipment that is in the fitness club. This information also identifies specific muscles worked by each exercise and how to target specific areas of each muscle for priority training. Also included is an exercise atlas that is a compilation of every exercise whether performed on a machine, with free weights, or without weights. This atlas includes detailed instructions on how to properly perform each exercise and information regarding the muscles worked. A workout menu presents a compilation of workout routines for whatever goal a user may have, i.e., muscle building, muscle toning, muscle maintaining, weight reduction, performance enhancement in life, athletics, or a particular sport.

The library also includes a science of exercise section that is a comprehensive volume of how variations in weight, number of repetitions, speed of repetitions, number of sets, speed of sets, circuit training, specialization, etc. can alter the effects of a workout. Reports and studies are also available in the library for users interested in historical and scientific studies that analyze data in all of the areas discussed above. A health database also presents information on supplements, vitamins, dietary considerations and other issues that impact a user's fitness. This health database compiles information about supplements, vitamins, and diets for specific workout goals such as weight loss, muscle gain, improved performance, etc. Such workout goals also include enhanced athletic performance for specific sports, physical therapy, and weight loss/gain. The main library combined with the virtual trainer is designed to provide a total picture to assist a user in designing, performing, and maintaining a workout for a specific fitness goal. From a commercial perspective, the system can sell advertising space that can target certain users depending upon a user's interests and medical/fitness goals.

The system can be packetized such that a user or fitness club can obtain or lease all or part of the complete system. Thus, a large fitness club or sports team can purchase a complete system for all of its members to use. A smaller club, physical therapy office, medical facility, school, or owner of a home gym can purchase only those parts of the system that are necessary for its members to access the system and use the equipment it has. In addition, an individual user can purchase an Internet-only personal program to allow access to the system remotely from home or when travelling. Also, a physician or doctor can purchase a specialized packet that allows remote access to the system for medical review and oversight. The system includes hardware and software, both of which can be sold or leased.

Various embodiments of the virtual trainer can embody different features. One embodiment can include educational monitors and individualized workout plan tracking via PIN# or ID card. This embodiment includes instruction on how to use specific equipment and tracks a user's time and intensity of workout. The information is accessible over the Internet for retrieval by medical professionals, insurance companies and individual users away from the club. Another embodiment may include monitoring by two-way video cameras on the equipment to record and replay the workout performance. The video can be viewed by the user and/or his/her coach/doctor for monitoring, correction and improvement. In another embodiment, the virtual trainer may include instantaneous feedback by physical monitors on the user and/or equipment. The physical monitors may be wired or wireless. Depending upon the information obtained, such monitors can provide on-screen feedback, coaching and/or actual stoppage of the equipment.

Insurance companies will find this system attractive because the monitoring and feedback can facilitate a user's exercise program, leading to improved fitness and decreased medical problems. The system may also find application through Government contracts for use with a new government run healthcare plan. An entity using this system will find revenue opportunities in system implementation, maintenance fees, and advertising from suppliers of supplements, vitamins, clothing, and medical professionals—to name a few.

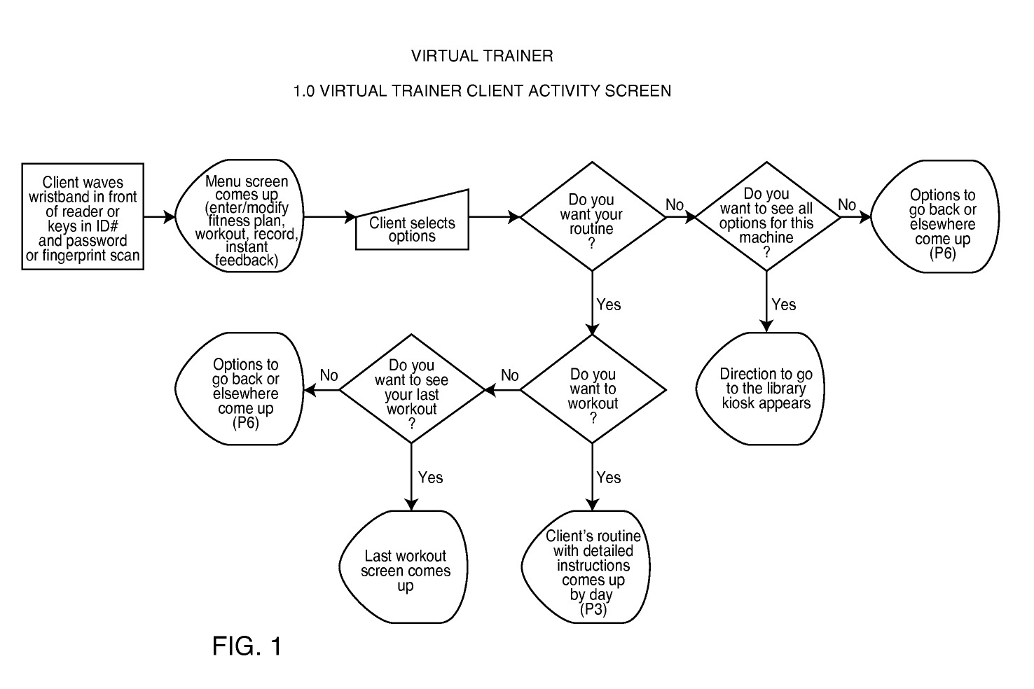

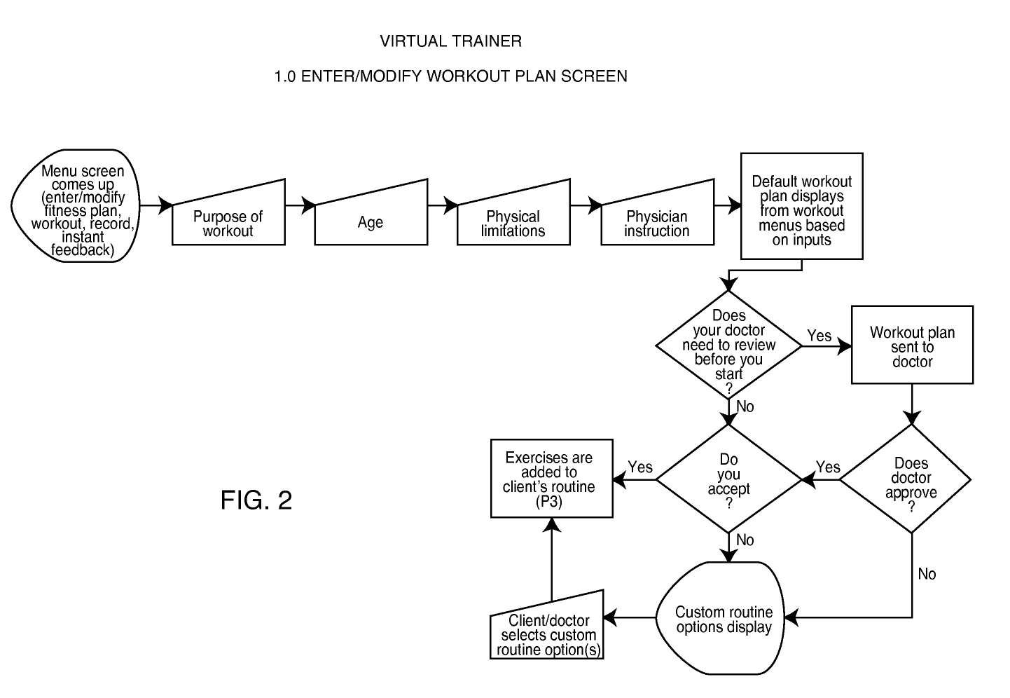

As illustrated in the figures, the virtual training system presents a user a number of on-screen options. FIG. 1 illustrates an activity screen where a user enters a PIN#, password, or ID card/tag/wristband to bring up the user's account. The user has an option to select an existing workout routine, review past workouts or review exercise options for a particular machine. FIG. 2 illustrates a workout plan screen whereby a user can generate a workout plan by providing varied information, i.e., goal, age, limitations, physician instructions, etc. The system can generate a default workout which can then be reviewed and modified as necessary.

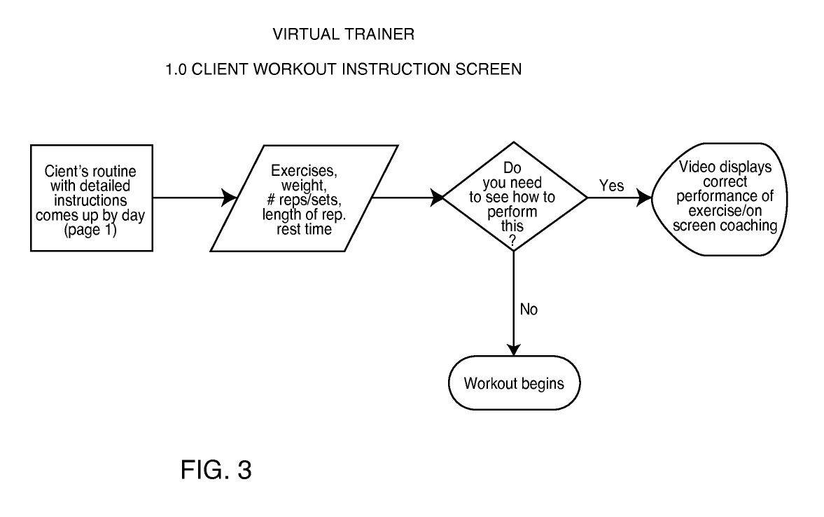

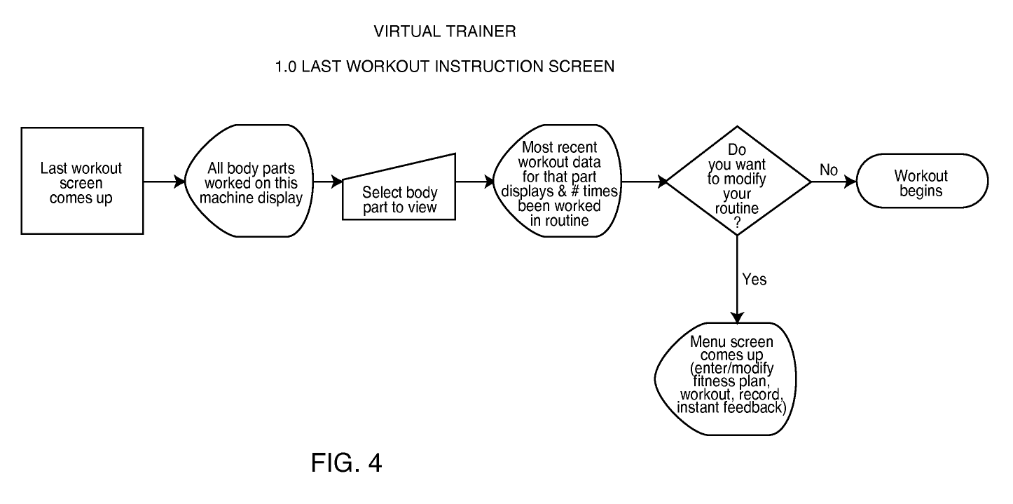

FIG. 3 illustrates the user workout instruction screen. On this screen, a user is told which exercise to perform, how much weight to use, how many repetitions and sets to perform, the length of the repetition and how much rest time. The user is also given the option to view a video demonstrating performance of the exercise. FIG. 4 illustrates the last workout instruction screen. On this screen, the muscles worked on a particular machine are displayed. Alternatively, the user can select to see all exercises performed for a particular muscle. The screen then displays the most recent workout data for the selected muscle and the number of times that muscle has been worked in the routine. The user is then given the option to modify the routine to change the number of times a particular muscle is worked in a routine.

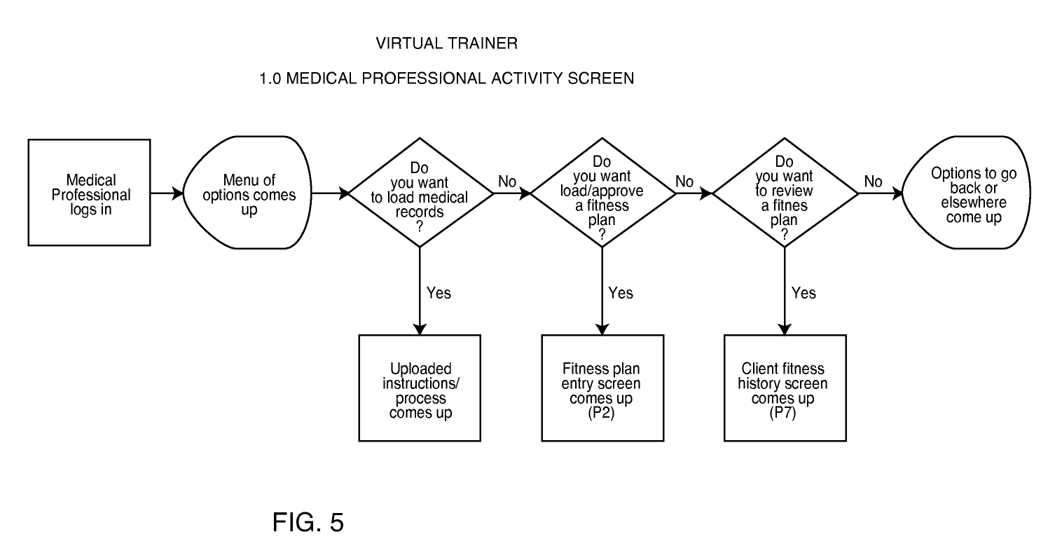

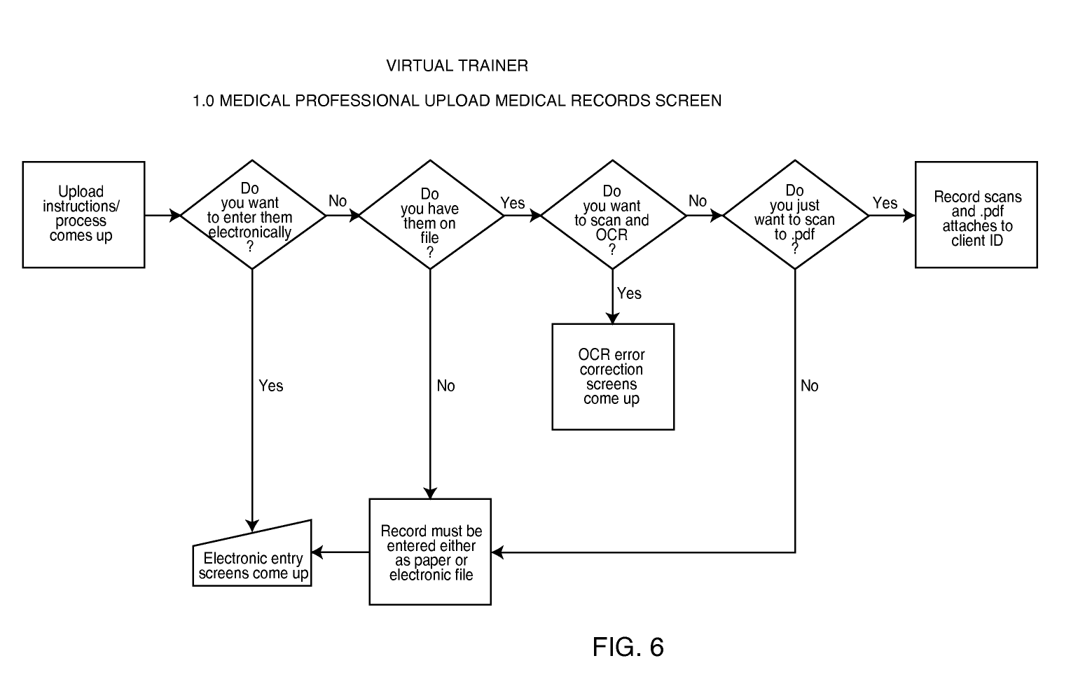

FIG. 5 illustrates a medical professional activity screen. On this screen, a medical professional may log-in to the system access a patient's records. The medical professional is given several options including to upload medical records, to load or approve a fitness plan, or to review a fitness plan. FIG. 6 illustrates the process for uploading medical records. The records may be entered either electronically or in scanned (PDF) format. The system may employ OCR with documents to make the documents searchable.

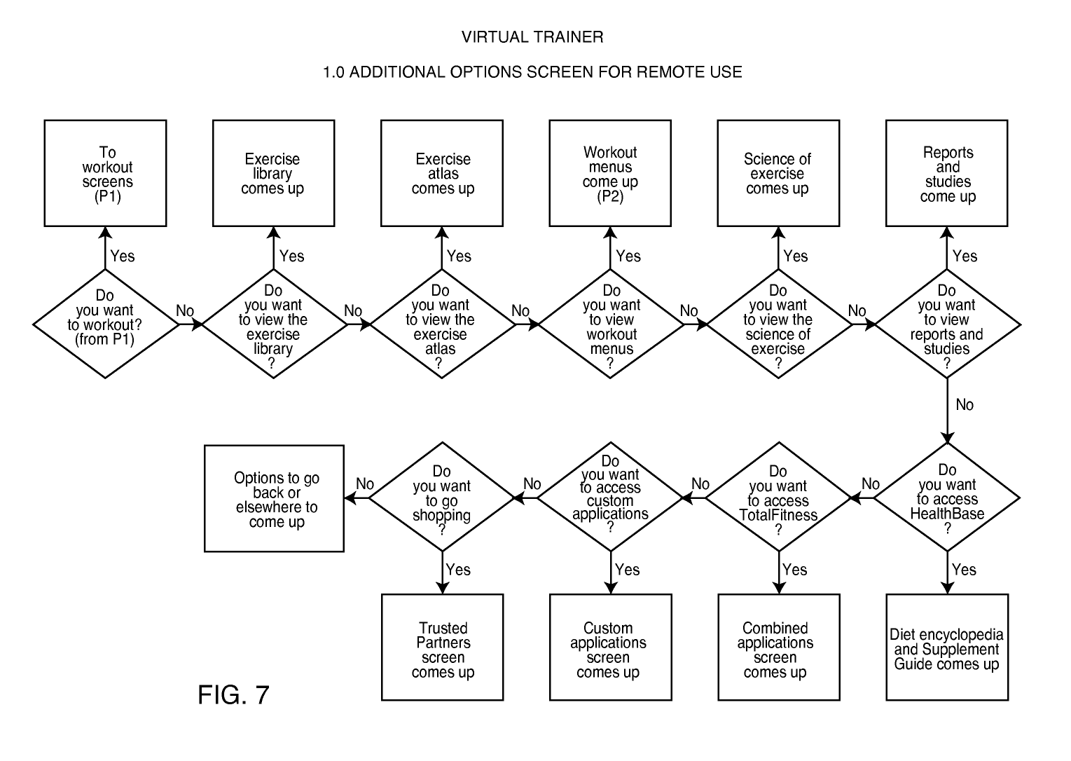

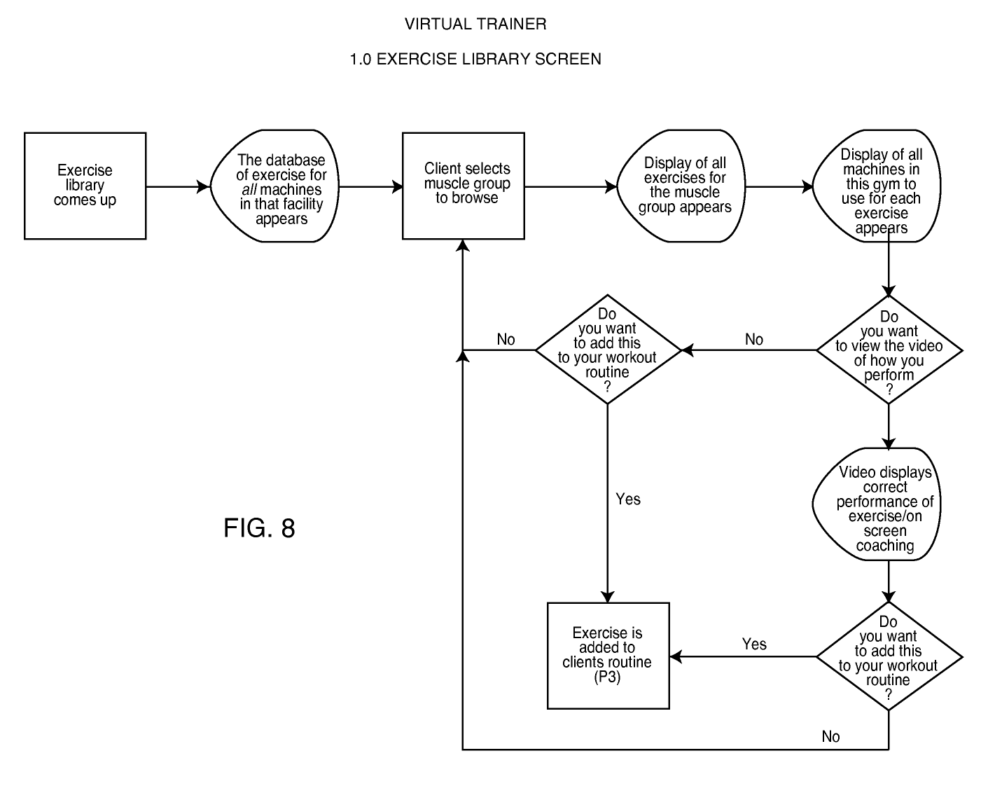

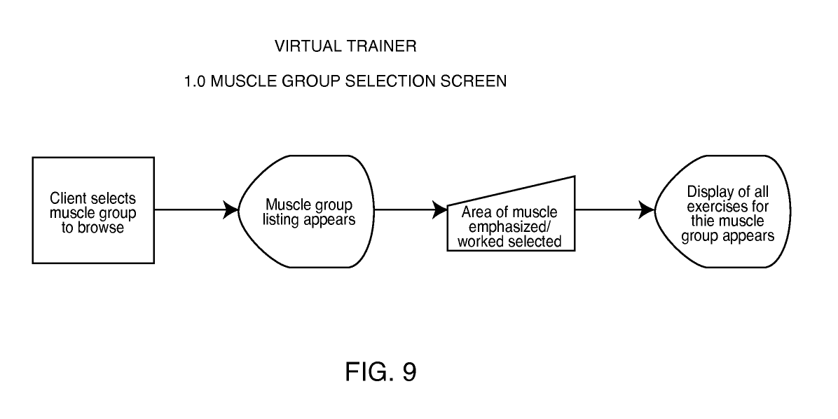

FIG. 7 illustrates several options available during remote use. A person accessing the system remotely can view workout screens, the exercise library, the exercise atlas, the workout menus, research/reports on exercise, advertising partners, custom applications, combined applications and the diet/supplement guide. The exercise library, as illustrated in FIG. 8, displays the database of exercises for all machines in a particular club. The information in this library is searchable by muscle group or by piece of equipment. With either of these searches, the user can elect to add a particular exercise to a workout routine and/or view a video of how the exercise is performed. FIG. 9 illustrates the muscle group selection screen. As shown, a user may select to view all exercises for a particular muscle group and select a specialization for a specific area of the muscle to be worked.

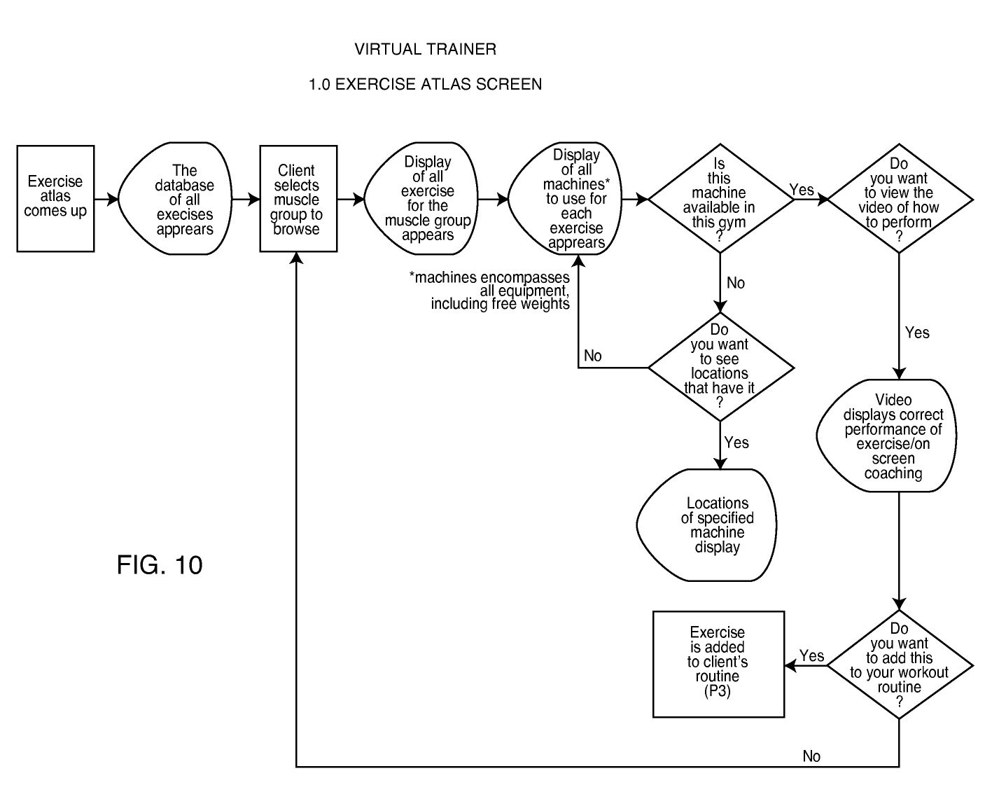

FIG. 10 illustrates the exercise atlas screen. The exercise atlas is a database of all exercises, regardless of the machines present in the facility. The atlas is searchable by muscle group and displays all exercises that target the selected muscle group and identifies all machines on which the exercises can be performed. As used here, machine refers not only to machines but free weights, dumbbells, and non-weight bearing exercises. The atlas then gives the user the ability to select a machine, determine if the machine is available in a particular facility, view a video of how the machine is used, and/or the option to add an exercise on the selected machine to a workout routine.

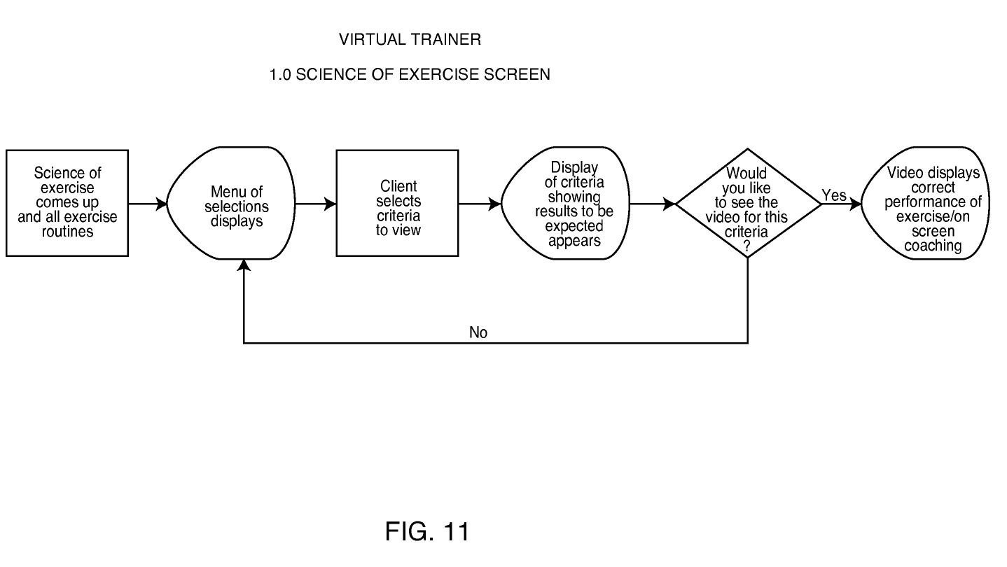

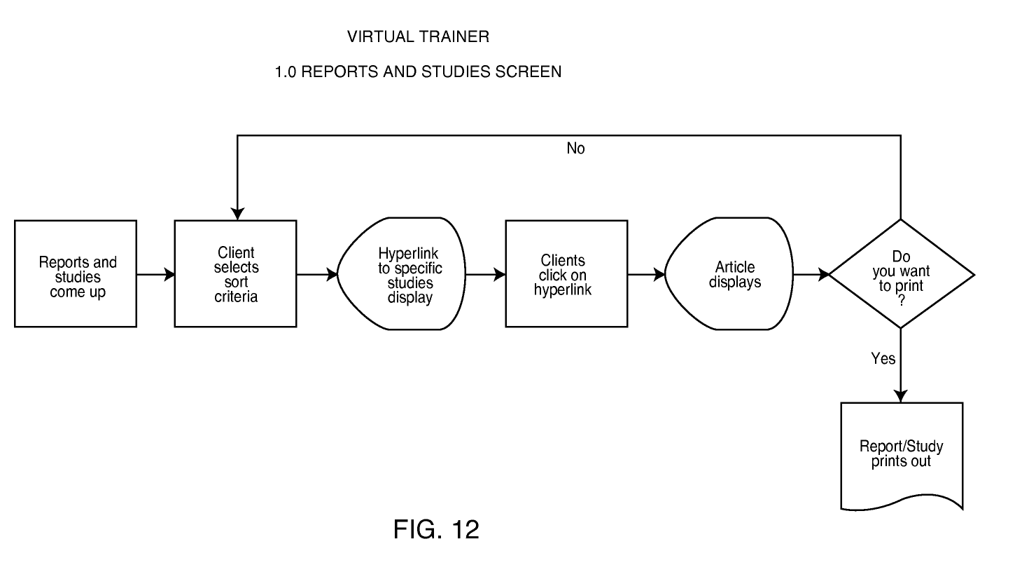

FIG. 11 illustrates the science of exercise screen. The science of exercise includes reference materials on criteria showing expected results from various exercises. The science of exercise is searchable by various criteria and gives the user the option to view a video on the reference materials. FIG. 12 illustrates a reports and studies screen. The reports and studies screen is searchable and presents links over the Internet to articles and give the option to print a particular article.

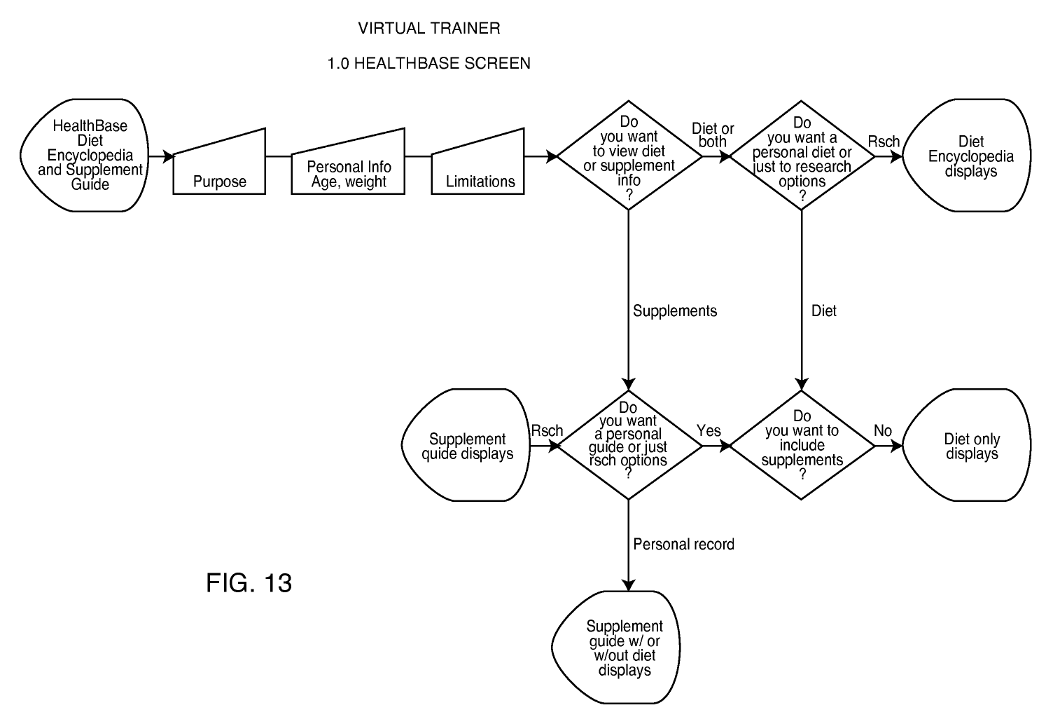

FIG. 13 illustrates a health database screen. The health database screen accepts input from a user include purpose of workout routine, personal information such as age, height and weight, and physical limitations of exercise. The user is then given the option of receiving diet or supplement information, a personal diet plan and/or research options.

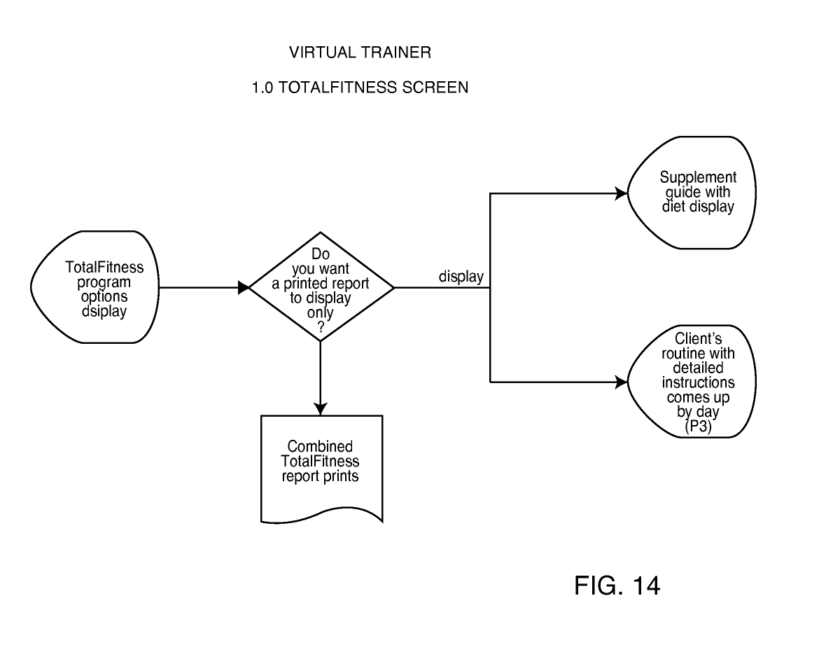

FIG. 14 illustrates a total fitness screen. The total fitness screen presents all facets of the workout routine prepared using the virtual trainer. The user can choose to display the workout routine with detailed instructions. The user can also choose to display a supplement/diet guide with the workout routine. The complete or any portion of the workout plan can then be printed from this screen.

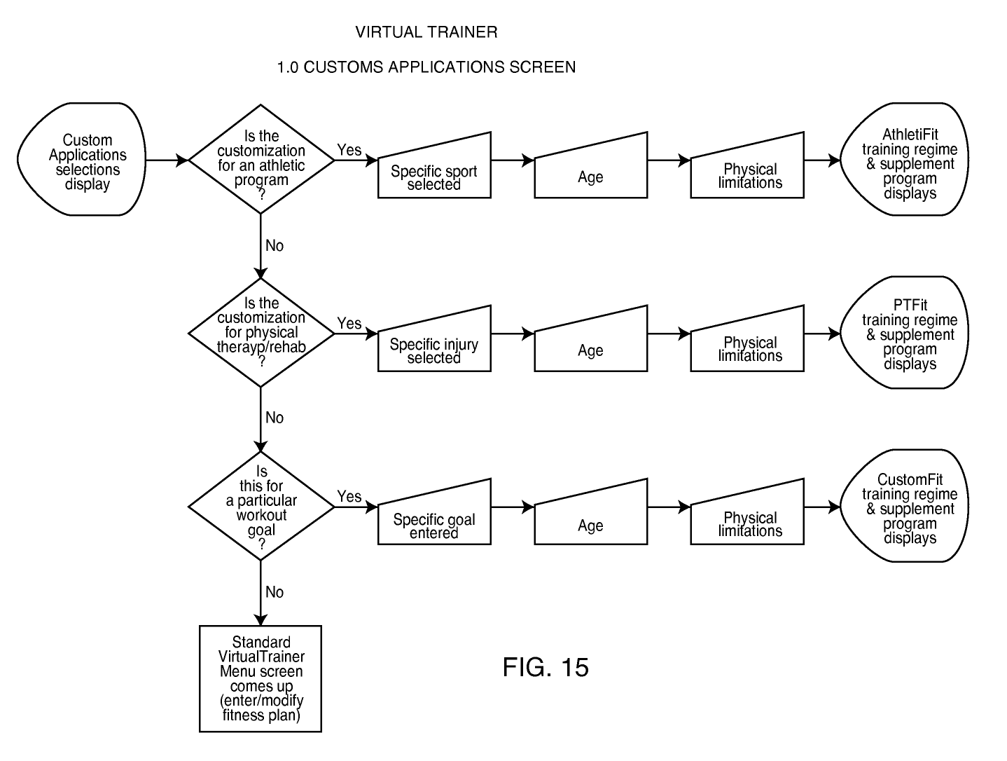

FIG. 15 illustrates a custom applications screen where a user can customize an exercise routine for a specific purpose. The user can customer the routine for an athletic program, physical therapy/rehab, or another particular workout goal. After inputting basic information such as the sport, injury or goal to be addressed, along with the user's age and any physical limitations, the applicable program or subroutine of the system generates and displays a workout routine with supplement/diet guides as needed.

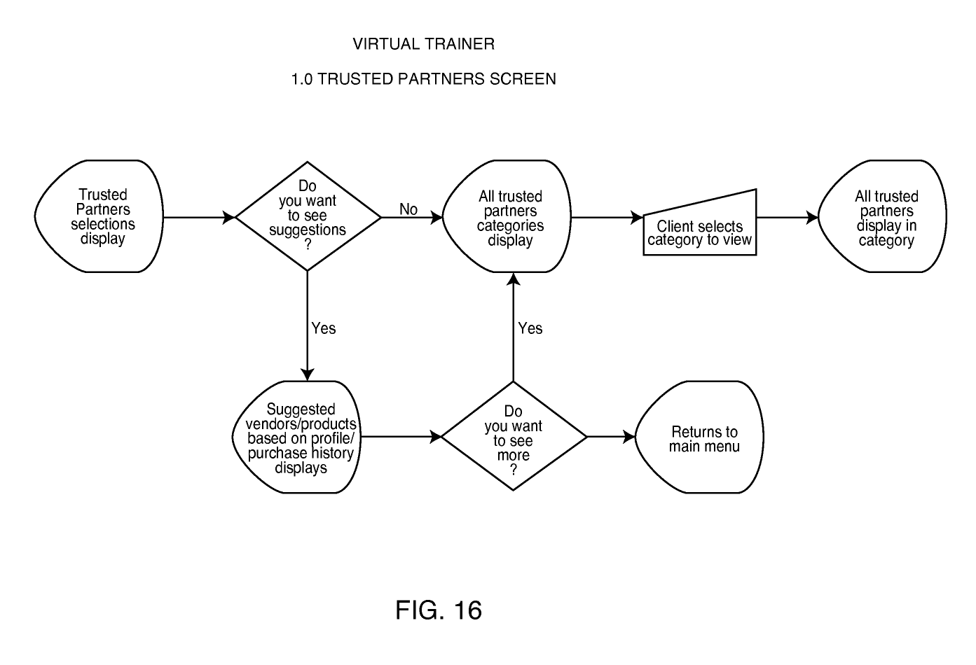

FIG. 16 illustrates a trusted partner's screen where users can see and review advertisements or presentations from various providers. The system can target specific providers for a user based upon the user's profile or purchase history. Alternatively, the system can display all providers or trusted partners to a user. The user may also select certain categories of providers to review.

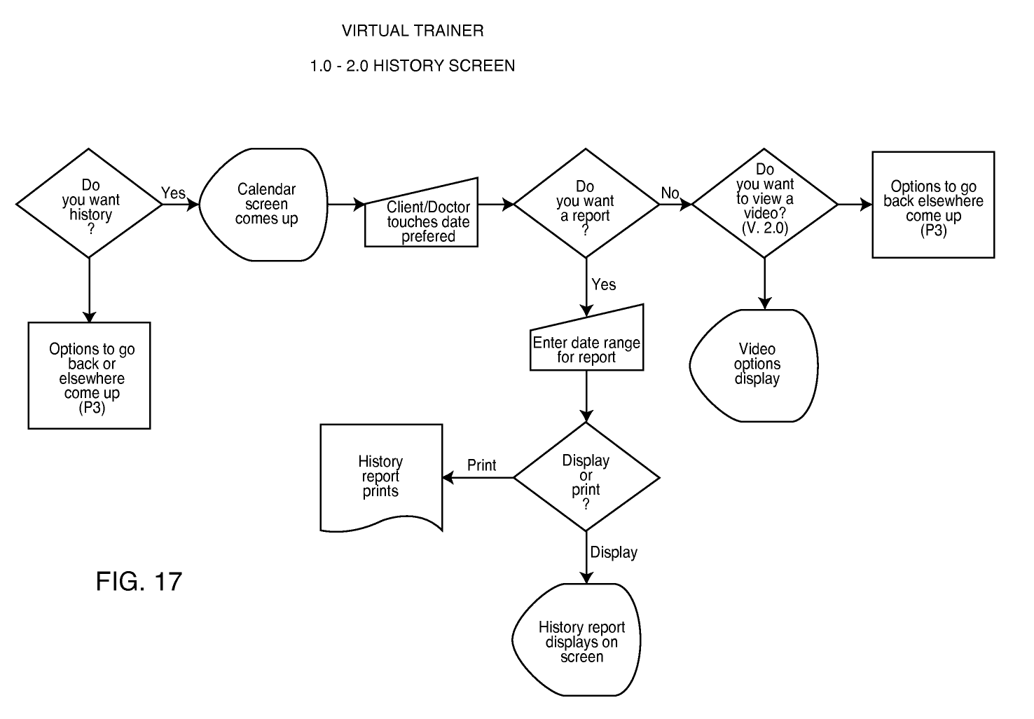

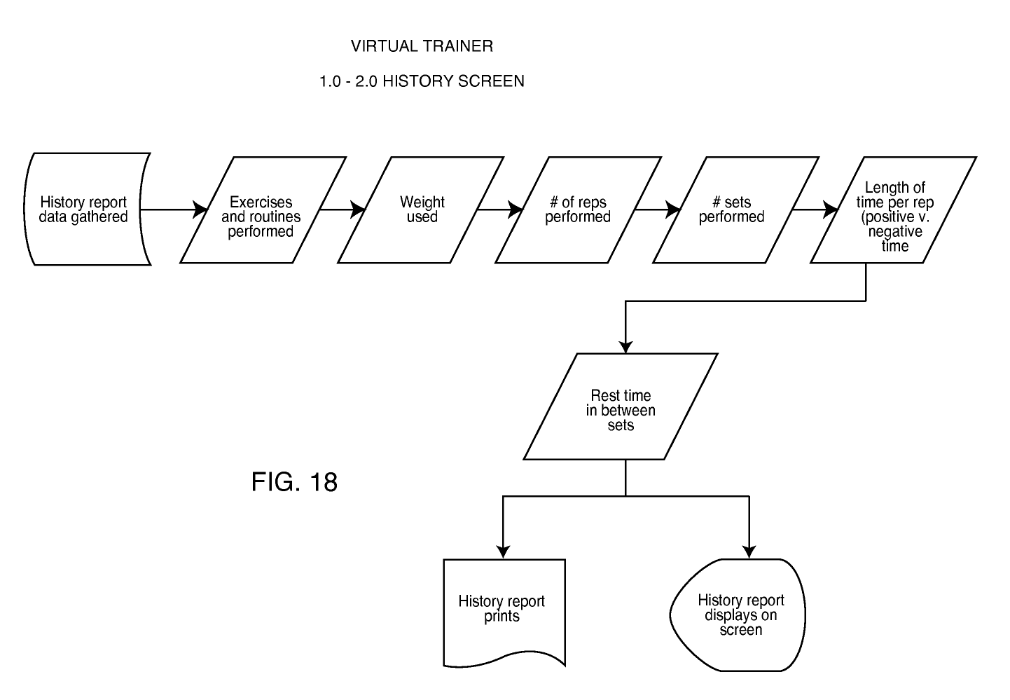

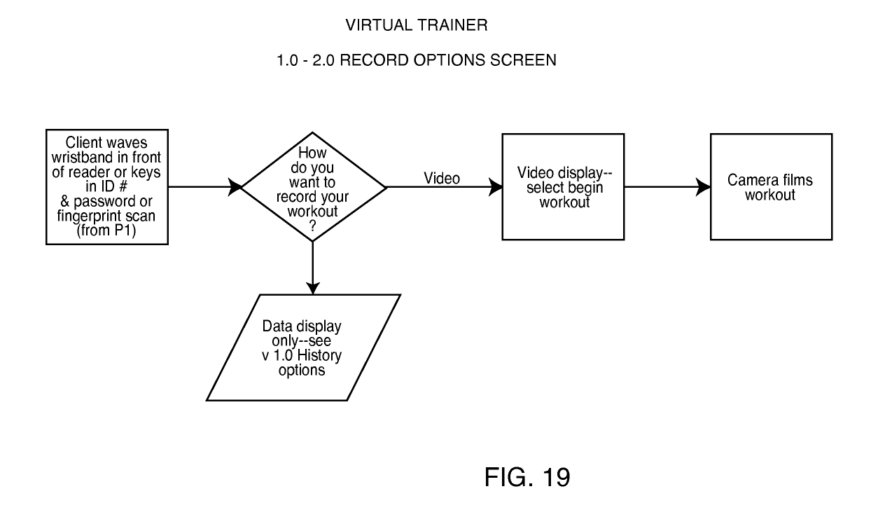

FIGS. 17 and 18 illustrate a history screen where a user can review the history of a workout routine and receive a report on the progress/results of the workout routine. The user can also view a video record of a particular workout session. The history report includes information such as exercises performed, weights used, number of repetitions/sets, length of time of each repetition and rest time between sets. FIG. 19 illustrates a record options screen whereby a user can record a particular workout either in data only format or by using a video camera associated with the piece of equipment.

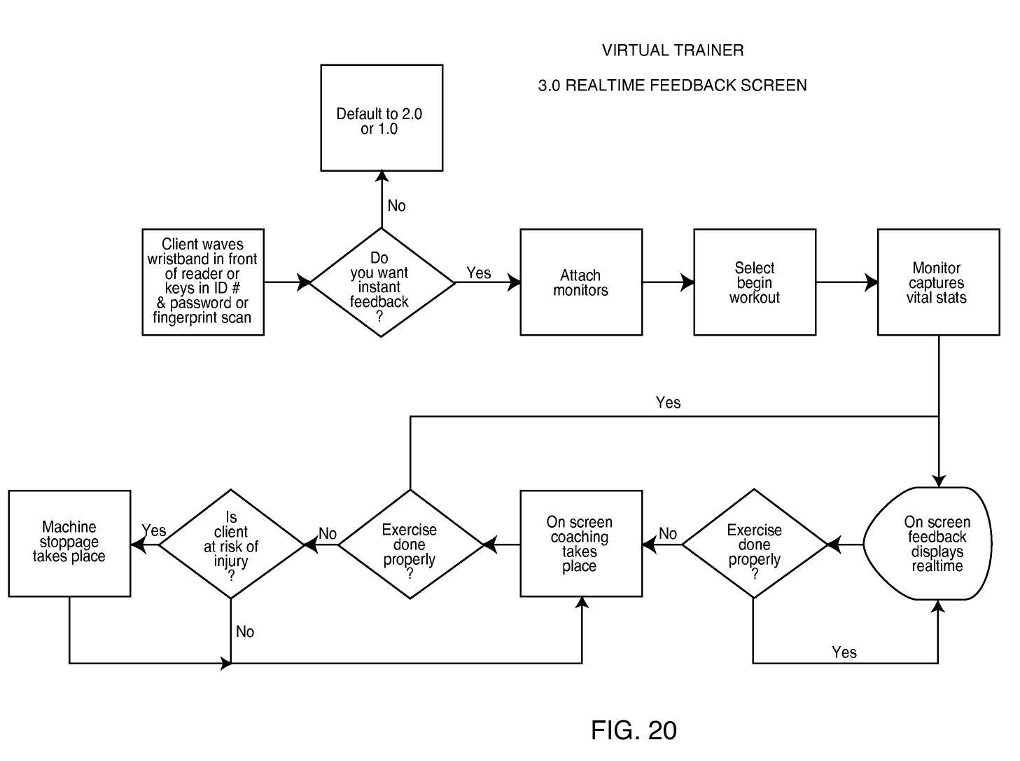

FIG. 20 illustrates a real-time feedback screen whereby a user can get instantaneous feedback on a workout. In the case illustrated, monitors are attached to the user prior to the workout. During the workout, the monitor captures vital statistics about the workout. The system can provide real-time feedback regarding whether the exercise was performed properly and on-screen coaching or guidance can be provided. If the system determines that a particular exercise is performed incorrectly or can otherwise result in injury/harm to the user, the system can stop the machine to prevent such injury/harm.

Discussing the system in more detail, a lifestyle information and evaluation system can include data from a multitude of parameters to be stored in one central location/system database. Then, the data can be retrieved and evaluated by various organizations or end users. For instance, information gathered on every aspect concerning one's overall wellness can be compiled. There are a multitude of parameters that can affect one's overall health and wellness discussed hereafter.

A person's dietary choice can greatly influence overall wellness. Data on a person's diet can come from a multitude of sources. When a person goes to the grocery store, it is common to use a frequent customer tag/membership card or to have an account associated with a particular person. It is very common for grocery stores to track individual purchases such that ads or special offers can be directly targeted. This information regarding the purchases of a particular person's food choices can also be used and analyzed to determine the nutritional value of their diet. Furthermore, when a person goes out to eat at a restaurant they use a credit card to purchase their meal. This information can also be compiled into the system's database. Some people order groceries over the internet to then have them delivered at their convenience. This information can also be compiled into the system's database.

Exercise is also a parameter that greatly affects one's overall wellness. In the past, the reporting of one's actual performance or execution of various exercises was reported by the person themselves. This method of self-reporting lacks accuracy and is susceptible to variability. As earlier discussed, when a person enters a gym and performs various exercises, this data can be captured and stored into the system's database.

Pharmaceutical records are also an important parameter that can be compiled in the system's database. These records can be entered by medical professionals during treatment, or from various pharmacies that are selling the drugs. Medical records can also be entered into the system. For instance, when you visit the doctor or the hospital, it is possible to compile those records such that the data can be stored in the system's database.

There are other parameters that can also be entered into the system to help determine one's overall wellness beyond the obvious parameters of race, height, weight, sex and age. One's genetic history can also indicate areas that may potentially become problematic in time. The health records of one's direct ancestors can help determine your wellness. For instance, having a father and grandfather who both experienced heart attacks would indicate there might be a potential for a heart attack later in life. These parameters should be evaluated when determining one's overall wellness and health.

Personal habits and marital status are also important parameters that need to be compiled. For instance, whether someone is a smoker or drinks heavily can greatly affect one's health. Purchase of tobacco and alcohol can be compiled when using a credit card or membership card. Other lifestyle choices and hobbies can affect wellness as well. For instance, ownership of a pet has been found to decrease stress and lengthen one's lifespan. The participation in activities such as mountain biking, surfing, snowboarding, yoga, martial arts may improve physical health but also add to increased chances of injury. Also, one's occupation can be a health parameter as some jobs can be quite stressful. This means that one's line of work and their status of work can affect their health. For instance, doctors and lawyers can have very stressful practices that increase the chance of developing a stress-related illness. Also, being unemployed or retired also factors into one's overall health.

Another parameter that can be added is one's driving record, criminal record, or the like which may show one's propensity to take risk. Risk takers tend to injure themselves more than people who don't take risks. Personality tests can also be entered into the system, along with any psychiatrist records. Stress-level tests can also be used to evaluate the stress a person is enduring. Stress can be caused by one's occupation, but can also be affected by one's finances. Financial security and other related money issues can affect one's physical health. Furthermore, even one's environment can affect your health. For instance, people living in Seattle tend to be more depressed due to the overcast weather.

Another parameter that can be added is information gathered from one's blackberry, iPhone or other personal communication device. These devices commonly have global positioning capability that can track and record the locations a person has visited. For instance, these devices can monitor whether one sped on the way to work, whether one really left the office to hit the gym during lunch, or whether one visited a local ice cream shop recently. All of this data can be recorded and uploaded into the system's database.

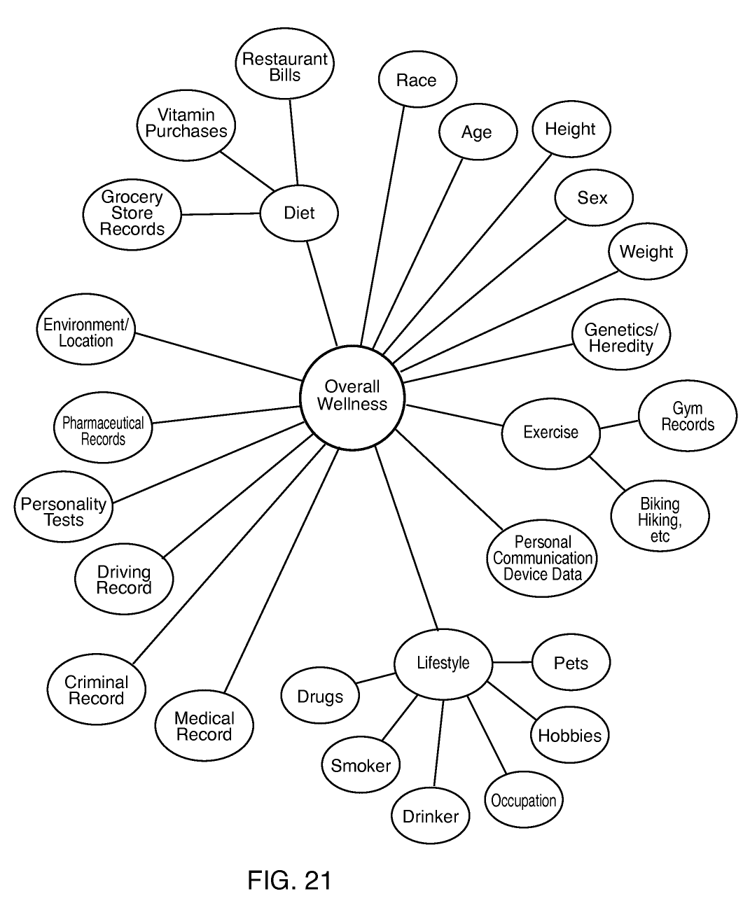

As can be seen, there are a whole range of parameters that can be compiled to determine one's wellness and health. FIG. 21 is a diagram illustrating the various wellness parameters that can be compiled into the system's database. Never before has all of the parameters been compiled and stored in one location so that an overall wellness of a particular person been determined. Once this information is compiled into a single location, it can be accessed for various reasons. For instance, a person purchasing health insurance can allow an insurance company/administrator to retrieve their wellness report from the database to determine the rates or available coverage they are willing to offer. Government agencies can also access the information to help determine which foods are beneficial or harmful to the population. Large scale studies can now easily be conducted which have larger sample sizes which reduces errors. Correlations between certain parameters can be compared with results to help researches and scientists lead to new discoveries.

The administrator or end user accessing the information from the system's database can also process the information using their own specialized algorithm. For instance, different parameters can be given more or less value when calculating the overall wellness of a particular person. For example, a life insurance company may want to emphasize the dietary parameters more than the exercise parameters when calculating their wellness factor. Other life insurance companies may want to emphasize more a person's heredity/genetics when calculating a wellness score. As can be seen, it is up to the end user to determine how best to use the data.

The administrator may include a variety of different people or organizations that have access to the electronic database. For example, the administrator can include not only the patient but also a medical doctor, a health services provider, an insurance company, groups performing clinical trials for either government or private research, homeland security, and other law enforcement agencies at either the state or federal levels. As can be seen by one skilled in the art, the administrator may include a variety of people and groups that can best use the electronic database.

Furthermore, a completeness factor can be calculated which indicates the completeness of a particular person's database. For instance, data may be missing about a person's family/genetic history. This data may be critical for the purpose it is being used. A person may have a high wellness and health score, but the accuracy of the score would be downgraded based on the lack of critical information. The wellness score could then be a range of scores, or a single score along with a completeness score. As can be seen, many administrators and organizations may devise their own specific algorithm for their specific needs and this disclosure is not intended to limit it to just one form of calculation/algorithm.

Other features and advantages of the present invention will become apparent from the following more detailed description, taken in conjunction with the accompanying drawings, which illustrate, by way of example, the principles of the invention.

What is claimed is:

1. A computer implemented process for creating an overall health wellness database for a plurality of patients, comprising:
creating an electronic database for receiving and storing health related information associated with a patient, wherein the health related information includes the patient's diet and exercise information;
providing access to the electronic database to the patient or to an administrator; and
evaluating the health related information for the patient to determine an overall wellness record for the patient;
wherein the overall wellness record is evaluated upon a series of factors applied to the health related information for the patient and upon a completeness of the health related information for the patient.

2. The method of claim 1, wherein the patient's diet information comprises food, vitamin, or prescription drug purchases received via a customer identifier associated with the patient and a vendor used at a time of purchase, or relating to a credit or debit card purchase associated with the patient.

3. The method of claim 2, wherein the patient's exercise information is received from a sensing element adapted to sense an exercise motion of the patient.

4. The method of claim 3, wherein the sensing element is in communication with an athletic device monitoring the exercise motion of the patient.

5. The method of claim 3, wherein the sensing element is integrated into a mobile device carried by the patient.

6. The method of claim 5, wherein the mobile device comprises a cell phone, a pager, or navigation device.

7. The method of claim 1, wherein the health related information comprises the patient's race, age, height, sex, and weight.

8. The method of claim 7, wherein the health related information comprises the patient's genetic and heredity history.

9. The method of claim 8, wherein the health related information comprises the patient's marital status.

10. The method of claim 1, wherein the health related information further comprises the patient's lifestyle information.

11. The method of claim 10, wherein the patient's lifestyle information includes information related to pet ownership, hobbies, or occupation.

12. The method of claim 10, wherein the patient's lifestyle information includes information related to the patient's use of alcohol, nicotine, or other drugs.

13. The method of claim 1, wherein the patient's health related information comprises a medical record.

14. The method of claim 1, wherein the patient's health related information comprises a driving record, a criminal record, a personality test, or a stress test.

15. The method of claim 1, wherein the patient's health related information comprises a financial record.

16. The method of claim 1, wherein the patient's health related information comprises a primary residence location.

17. The method of claim 2, wherein the administrator is a medical doctor, a health services provider or an insurance company.

18. A computer implemented process for creating an overall health wellness database for a plurality of patients, comprising:
creating an electronic database for receiving and storing health related information associated with a patient, wherein the health related information includes the patient's diet and exercise information;
obtaining the health related information from monitoring behavior of the patient;
providing access to the electronic database to the patient or to an administrator including a medical doctor, a health services provider, an insurance company, a group performing clinical trials for either government or private research, a homeland security department, and other law enforcement agencies at either a state or federal level; and
evaluating the health related information for the patient to determine an overall wellness record for the patient;
wherein the overall wellness record is evaluated upon a series of factors applied to the health related information for the patient and upon a completeness of the health related information for the patient,

19. The method of claim 18, wherein the patient's diet information comprises food, vitamin, or prescription drug purchases received via a customer identifier associated with the patient and a vendor used at a time of purchase, or relating to a credit or debit card purchase associated with the patient.

20. The method of claim 19, wherein the patient's exercise information is received from a sensing element adapted to sense an exercise motion of the patient.

21. The method of claim 20, wherein the sensing element is in communication with an athletic device monitoring the exercise motion of the patient.

22. The method of claim 20, wherein the sensing element is integrated into a mobile device carried by the patient including a cell phone, a pager, or navigation device.

23. The method of claim 18, wherein the health related information comprises the patient's race, age, height, sex, weight, genetic history, heredity history, or marital status.

24. The method of claim 18, wherein the health related information further comprises the patient's lifestyle information including information related to pet ownership, hobbies, occupation or the patient's use of alcohol, nicotine, or other drugs.

25. The method of claim 18, wherein the patient's health related information comprises a medical record, a driving record, a criminal record, a personality test, a stress test, a financial record, or a primary residence location.
